(19) United States
(12) Patent Application Publication
(10) Pub. No.: US 2014/0222561 A1
(43) Pub. Date: Aug. 7, 2014

(54) Cross-Platform Advertisement Targeting

(71) Applicant: Facebook, Inc., Menlo Park, CA (US)

(72) Inventor: Nipun Mathur, Menlo Park, CA (US)

(21) Appl. No.: 13/758,779

(22) Filed: Feb. 4, 2013

(51) Int. Cl. G06Q 30/02

(52) U.S. Cl. CPC G06Q 30/0255; G06Q 30/0267
USPC 705/14.53

(57) ABSTRACT

An online system, such as a social networking system, enables targeted advertising to its users across platforms, such as mobile applications, desktop browsers, and mobile browsers. The online system stores interactions with advertisements or other content from multiple platforms with a user identifier. When an advertisement request is received including the user identifier, the stored interactions associated with the user identifier are retrieved, allowing an advertisement to be selected based on user interactions through various platforms. This improves advertisement delivery, such as advertisement retargeting, and conversion tracking.

### BACKGROUND

The present disclosure relates to advertising, and in particular to selecting advertisements for users of an online system across multiple devices and tracking user interactions with those advertisements.

Advertisement revenue provides an important revenue stream for social networking systems and other online systems. To increase the likelihood of a user interacting with an advertisement, which provides revenue to the online system, prior user interactions with advertisements are used in advertisement selection. If a user interacts with an advertisement associated with an entity, there is an increased likelihood that the user will interact with additional advertisements associated with the entity; hence, additional advertisements associated with the same entity are likely to be presented to the user.

However, users increasingly interact with content using multiple devices. For example, users frequently access a social networking system from desktop computers as well as smart phones or other mobile devices. Conventional techniques for advertisement selection do not account for a user's interactions across various devices. For example, user interactions with advertisements on a desktop computer are not used to select advertisements for presentation via a mobile device. This increases the likelihood that a user is shown duplicate advertisements across different devices, reducing the potential revenue to an online system providing advertisements. Similarly, the inability to identify the same user across devices makes it impossible to track impressions, conversions, and other user interactions with advertisements across devices.

Additionally, native applications on mobile devices do not maintain cookies or provide similar functionality for tracking and analyzing a user's activity on the mobile device. Even if a web browser on a mobile device maintains cookie tracking a user's browsing history, conventional native applications on the mobile device are unable to access these cookies, limiting the information available to the native applications for advertisement selection. This limits the ability of interactions with advertisements via native applications to be used in advertisement selection for the mobile device and for other devices with which a user interacts with content.

### SUMMARY

Embodiments of the present disclosure allow an online system, such as a social networking system, to account for user interactions with advertisements received from multiple types of devices when selecting an advertisement to present to the user. As users may interact with advertisement from multiple types of devices, such as mobile devices and computing devices (e.g., desktop or laptop computers), the online system associates interactions with advertisements received from multiple types of devices to reduce the likelihood that the user is presented with the same advertisement, or a similar advertisement, using different types of devices. Interactions with advisements include user identifying information used by the online system to retrieve a user profile. A description of an advertisement with which a user interacted is stored in the user profile.

If a user interacts with an advertisement using a computing device, a cookie is stored by the computing device including user identifying information and the advertisement. The online system accesses the cookie to identify the advertisement with which the user interacted and the user identifying information, and stores a description of the advertisement in a user profile associated with the user identifying information. However, if a user interacts with an advertisement using a client application executing on a mobile device, the client application accesses a shared memory location of the mobile device to retrieve the user identification information. An application associated with the online system and executing on the mobile device stores the user identification information in the shared memory location, allowing other applications on the mobile device to retrieve the user identification information from the shared memory location. In one embodiment, the user identification is hashed or otherwise encoded before being stored in the shared memory location. The client application then identifies the advertisement with which the user interacted to the online system along with the retrieved user identification information.

Thus, advertisements with which the user interacted are identified by the user profile in the online system regardless of the device used to interact with the advertisement. When a request to present an advertisement to the user is subsequently received, the online system retrieves user identification information from the request and retrieves the user profile associated with the user identification information. Based on the advertisements identified by the user profile, the online system selects an advertisement for presentation to the user. For example, the online system excludes advertisements identified by the user profile from selection so a new advertisement is selected for presentation to the user.

### BRIEF DESCRIPTION OF THE DRAWINGS

FIG. 1A illustrates a block diagram of a system environment for retrieving advertisements targeted to a mobile device user using the user's association with a social network, in accordance with an embodiment.

FIG. 1B illustrates an example display of an active client application on a mobile device presenting an advertisement selected for a user, in accordance with an embodiment.

FIG. 2 illustrates a block diagram of a system environment for serving an advertisement to users of a social network, in accordance with an embodiment.

FIG. 3 is an example block diagram of a system architecture of a social networking system, in accordance with an embodiment.

FIG. 4 illustrates a flowchart of a process for retrieving a targeted advertisement from a social networking system using a mobile device, in accordance with an embodiment.

The figures depict various embodiments of the present disclosure for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

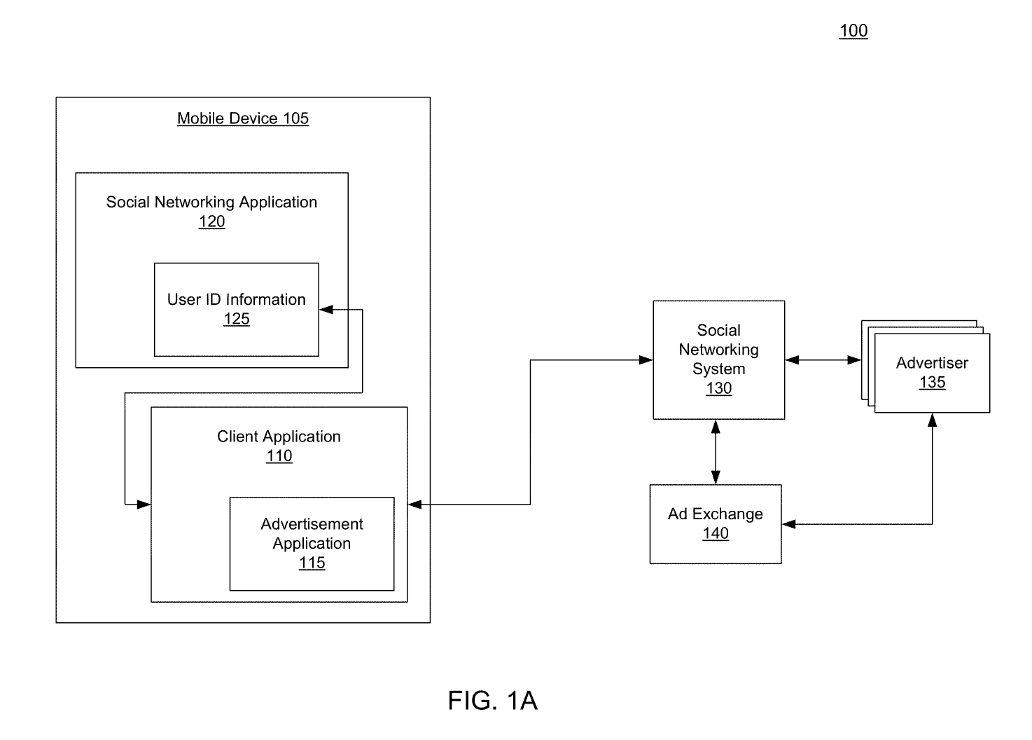

FIG. 1A is a block diagram of system environment 100 for using a mobile device user's association with a social networking system to retrieve advertisements targeted to the user. The system environment 100 shown by FIG. 1A includes a mobile device 105 including a client application 110. The client application 110 may be any application presenting content to a user of the mobile device 105. Content presented by the client application 110 may include one or more advertisements. For example, the client application 110 is a news application displaying news and advertisements to a mobile device user.

To provide advertisements, the client application 110 includes an advertisement application 115 that retrieves advertisements to be presented to the user. Advertisements which are associated with a user profile or with a group of user profiles are known as targeted advertisements. The advertisement application 115 retrieves user identification (“ID”) information 125 for the user stored on the mobile device 105. In one embodiment, user ID information 125 is associated with a social networking application 120 included on the mobile device 105. For example, user ID information 125 includes a user identifier uniquely associating the user with a user profile within a social networking system 130. The user ID information 125 may be stored in a shared memory location of the mobile device 105 to more readily allow the social networking application 120 and the advertisement application 115 to access the user ID information 125.

In one embodiment, the social networking application 120 hashes the user ID information 125 and stores the hashed user ID information in the shared memory location of the mobile device 105. The social networking application 120 may generate the hash from any item of information associated with a user. Examples of items of information associated with a user include an account identifier, an email, a login name, an identifier used by the social networking system 130, or any other suitable information. The hashed user ID information is retrieved by the advertisement application 115 or by the client application 120 and communicated to the social networking system 130. Using user ID information stored by the social networking system 130, the social networking system 130 generates hash identifiers and compares the received hashed user ID information to the hash identifiers. If a hash identifier matches the hashed user ID information, the social networking system 130 retrieves a user profile associated with the hash identifier. The received user profile may be used to obtain information about a user for selecting an advertisement or to store information identifying an advertisement with which a user interacted with using the mobile device 105. Hashing of user ID information is further described in U.S. patent application Ser. No. 13/306,901, filed on Nov. 29, 2011, which is hereby incorporated by reference in its entirety.

The advertisement application 115 sends a request for an advertisement to a social networking system 130 that includes the user ID information 125. In some embodiments the request for an advertisement may additionally include one or more request parameters. Request parameters are conditions which the social networking system 130 may use to limit advertisements provided to the client application 110. For example, a request parameter causes the social networking system 130 to select advertisements that have not been previously displayed to the user.

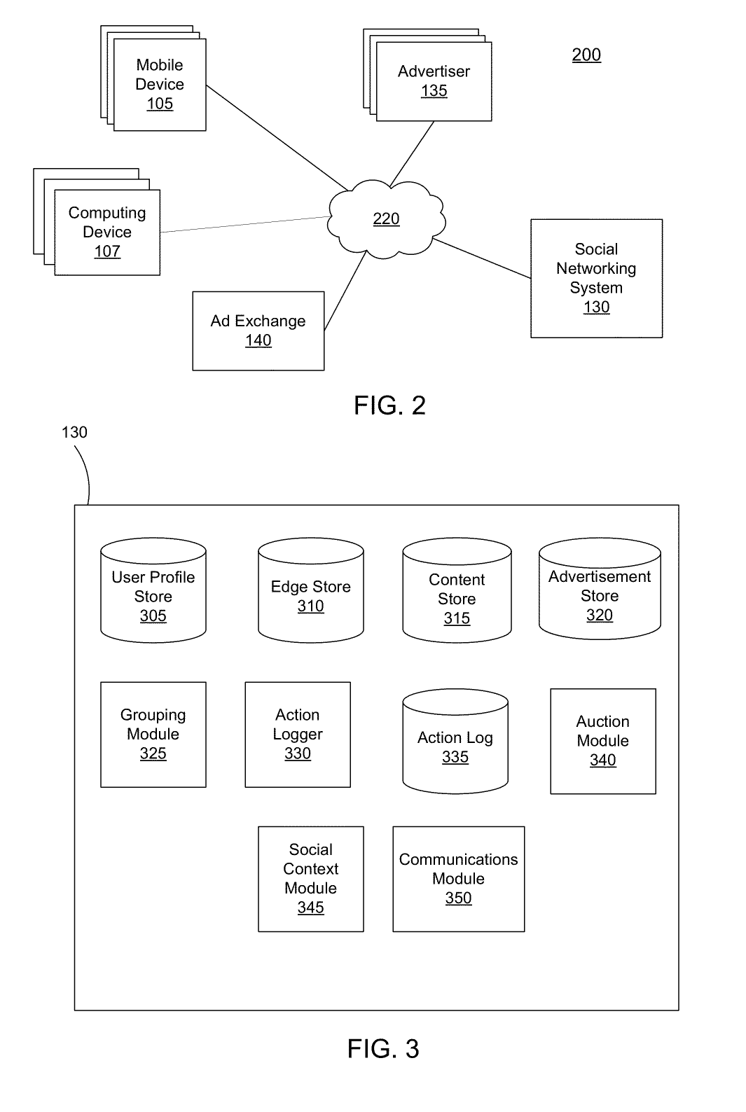

The social networking system 130, further described below in conjunction with FIG. 3, selects one or more advertisements using the user ID information 125 and any additional request parameters from the requests for advertisements. One or more of the selected advertisements are provided to the client application 110 by the social networking system 130. In some embodiments, the social networking system 130 embeds social context information within a selected advertisement if the user identified by a request for an advertisement is presently logged into social networking system 130, via, a social networking application 120, a browser located on mobile device 105, or any other suitable mechanism.

The social networking system 130 selects the advertisement from one or more candidate advertisements, which are each associated with at least one advertisement (“ad”) object. An ad object includes an advertisement and an associated bid price. An advertisement generally includes any communication intended to cause the recipient of the communication to take some action concerning a product or service. For example, an advertisement includes an offer for a deal.

One or more advertisers 135 provide ad objects to social networking system 130. In some embodiments, an advertiser 135 provides the ad object directly to the social networking system 130. Alternatively, an advertiser 135 may provide the ad object to social networking system 130 indirectly by using an ad network or an ad exchange 140.

Ad objects may also include targeting criteria that specifies characteristics of social networking system users to receive a particular advertisement. An advertiser 135 may provide an ad object without targeting criteria. If no targeting criteria are provided, the social networking system 130 may analyze the content of the ad object to infer targeting criteria based on a fuzzy matching algorithm that may use the types of interactions performed by users, user characteristics, and/or types of connections between users in the group as characteristics.

Social networking system 130, as further described below, maintains user profiles, edge objects, and content objects to provide information about its users. These user profile objects, edge objects, and content objects may be analyzed to identify users matching one or more targeting criteria of an advertisement. For example, groups of users having a common characteristic satisfying one or more targeting criteria are identified by social networking system 130. One or more targeted advertisements are associated with users matching one or more targeting criteria. For example, the social networking system 130 associates one or more archery-related advertisements with users matching one or more targeting criteria of the archery-related advertisements. For example, the social networking system generates a group of users matching one or more targeting criteria using user identifiers associated with the users in the group; thus, based on a user identifier, the targeting criteria matched by a group of users may be associated with user identifiers of users matching the targeting criteria, allowing more efficient identification of targeting criteria matched by an identified user. Alternatively, targeting criteria matched by a user are associated with the user, allowing retrieval of the user's matching targeting criteria based on a received user identifier.

The social networking system 130 extracts the user identifier from the received user ID information 125 and determines one or more targeting criteria satisfied by the corresponding user. Based on the targeting criteria, the social networking system 130 identifies one or more candidate advertisements for the identified user. Any request parameters associated with the targeted request for an advertisement are extracted and applied by the social networking system 130 to filter the pool of candidate advertisements. For example, if a request parameter dictates that the targeted advertisement has not been previously provided to client application 110, social networking system 130 removes previously presented advertisements from the candidate advertisements.

From the candidate advertisements, the social networking system 130 selects an advertisement associated with one or more targeting criteria satisfied by the user identified from the received user ID information 125. For example, an advertisement associated with a user identifier included in a group of user identifiers matching targeting criteria is selected. As another example, the social networking system 130 performs an auction based on the expected value of each of the candidate advertisements and selects the advertisement based on the auction. An internal auction, an external auction, or both may be used by the social networking system 130 to select a targeted advertisement to provide to client application 110. In some embodiments, the user social networking system 130 limits the candidate advertisements included in the objects. For example, other information about the user or users connected to the user is used to select a subset of the candidate advertisements included in the auction. Alternatively, the candidate advertisements included in the auction are not limited.

In some embodiments, the social networking system 130, or another advertising provider, may select of the advertisement based on information about the user stored by the social networking system 130. For example, information about the user maintained by the social networking system 130 indicates that the user has previously viewed content from, or is associated with (e.g., a connection exists in the social networking system between the user and the advertiser), the candidate target advertisements' advertisers. This information may increase the likelihood that the advertisement selected is from an advertiser with which the user has previously interacted, allowing advertisements to be retargeted based on content viewed by the user via the mobile device 105.

In some embodiments, the social networking system 130 may also embed social context information into a selected advertisement. To embed social context information, the social networking system 130 determines whether the user is logged into the social networking system 130 via a social networking application 120 on mobile device 105, a browser operating on mobile device 105, etc. If the user is logged onto the social networking system 130, the social networking system 130 may embed social context information associated with the user into the selected advertisement. Social context information identifies actions with the advertisement or with objects associated with the advertisement by other users of the social networking system 130 connected to the user of the mobile device 105. For example, if user X is connected to users Y and Z, and user Y is has expressed a preference for a page in the social networking system 130 associated with a product in a selected advertisement, the selected advertisement is modified to include social context information that “user Y likes this product” when delivered to user X.

The social networking system 130 then provides the selected advertisement to the client application 110, which presents the selected advertisement to the user along with any embedded social context. For example, the client application 110 displays the selected advertisement to the user, plays audio associated with the selected advertisement for the user, or otherwise presents the selected advertisement to the user.

FIG. 1B illustrates an example display 142 of an active client application 110 on mobile device 105 presenting a selected advertisement 150 to the user. As used herein, an “active application” is an application that is currently presenting content to the user. In the example of FIG. 1B, the client application 110 is a news application delivering client content 145 to the user, and the selected advertisement 150 is embedded within content presented by the display 145. However, in other embodiments, the selected advertisement 150 may be presented in a separate display, such as a pop up window, a banner, etc. In FIG. 1B, the social networking system 130 determined that the user satisfies one or more targeting criteria identifying users with an interest in archery; hence, the selected advertisement 150 is related to archery.

Additionally, in the example of FIG. 1B, the social networking system 130 determined that the user was logged into social networking system 130 when the selected advertisement is requested. Hence, the selected advertisement 150 in FIG. 1B includes social context information 155.

### System Architecture

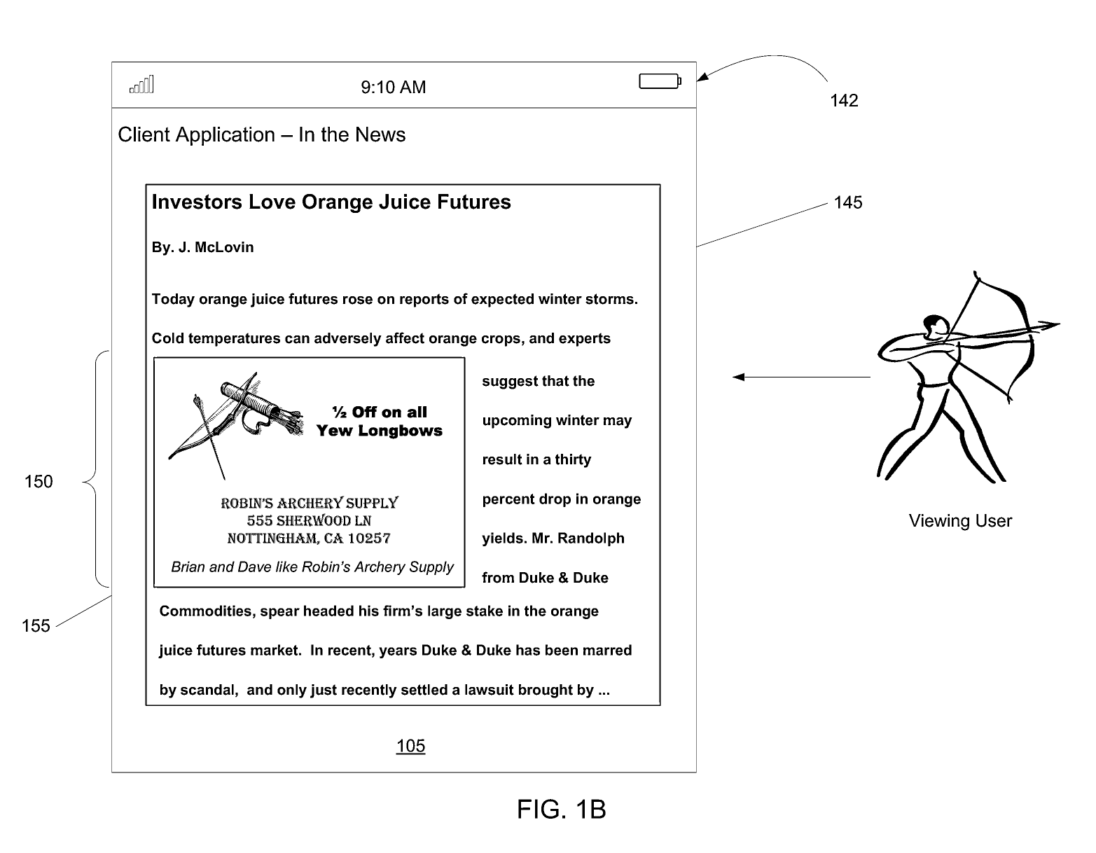

FIG. 2 illustrates a block diagram of a system environment 200 for serving an advertisement to users of the social network. The system environment 200 includes one or more mobile devices 105 and computing devices 107 coupled to the social networking system 130, to one or more advertisers 135, and to an advertisement (“ad”) exchange 140 via a network 220. In various embodiments, the system environment 200 may be organized in an alternative topology or configuration, and include different and/or additional modules.

The advertisers 135 provide ad objects to entities in system environment 200, and one or more of the ad objects are selected for presentation to a user of mobile device 105. The ad exchange 140 facilitates bidding, buying, selling, or some combination thereof, of ad objects from advertisers 135 to systems facilitating delivery of advertisements associated with the ad objects to their intended audience (e.g., all users, targeted to particular groups, etc.).

The mobile devices 105 comprise one or more computing devices capable of receiving user input as well as transmitting and/or receiving data via the network 220. Examples of a mobile device 105 include a personal digital assistant (PDA), a mobile telephone, a smart-phone or other devices operating without using cookies describing user actions. Mobile devices 105 may be equipped for cellular communication, Wi-Fi communications, or both.

The computing devices 107 are also capable of receiving user input as well as transmitting and/or receiving data via the network 220, but are capable of storing cookies describing user actions. Examples of computing devices include a desktop computer, a laptop computer, a netbook computer, or other similar device.

As discussed above, each mobile device 105 includes the social networking application 120 and the client application 110. The social networking application 120 allows a social networking system user to exchange data with the social networking system 130 via a mobile device 105 and the network 220. User identification (ID) information for each user of a mobile device 105 previously accessing the social networking system 130 via the social networking application 120 is stored on the mobile device 105.

The client application 110 may be any application capable of presenting content to the mobile device user and is configured to present advertisements in conjunction with client content. For example, client application 110 may be a news application that displays advertisements to the user along with news content. Additionally, client applications 110 may differ across different mobile devices 105. For example, the client application 110 may be a news application on a mobile device 105 and may be a weather application on a separate mobile device 105.

As discussed above in conjunction with FIG. 1A, a client application 110 includes an advertisement application 115 that sends requests for advertisements to the social networking system 130. The advertisement application 115 retrieves the user ID information 125 associated with the social networking application 120 that is stored in a shared memory location of the mobile device 105. Alternatively, the advertisement application 115 causes the client application 110 to retrieve the user ID information 125 from the shared memory location. By storing the user ID information 125 in a shared memory location, the social networking application 120 allows other applications, such as the client application 110, to identify a social networking system user operating the mobile device 105. This allows the other applications to provide advertisements that are based on information maintained by the social networking system 130 about the user corresponding to the user ID information 125. In embodiments where the user ID information 125 is associated with multiple users, the advertisement application 115 may select components of the user ID information 125 that are associated with one or more users. Using the user ID information 125, the advertisement application 115 sends a request for an advertisement including the user ID information 125 to the social networking system 130. The advertisement application 115 receives an advertisement selected by the social networking system 130, and the advertisement application 115 communicates with the client application 110 to display the received advertisement. In some embodiments, the advertisement application 115 may be created using a software development kit (SDK). The social networking system 130 may make available the SDK software to software developers. And in some instances, the social networking system 130 may charge a fee for use of the SDK software.

The mobile devices 105 are configured to communicate via network 220. A mobile device 105 may execute an application (e.g., client application 110, social networking application 120, etc.) that interacts with the social networking system 130 through an application programming interface (API) running on the native operating system of the mobile device 105, such as IOS® and ANDROID™. Additionally, the advertisement application 115 may allow interactions between the client application 110 and the social networking system 130 and/or the social networking application 120. In some embodiments, the mobile device 105 executes an application allowing a user of the mobile device 105 to receive an advertisement from the social networking system 130 or to otherwise interact with the social networking system 130.

In one embodiment, network 220 uses standard communications technologies and/or protocols. Thus, network 220 may include wired and/or wireless links using technologies such as Ethernet, 802.11 family of standards, worldwide interoperability for microwave access (WiMAX), 3G, 4G, CDMA, digital subscriber line (DSL), etc. Examples of networking protocols used on the network 220 include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 220 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 3 is an example block diagram of a system architecture of the social networking system 130. The social networking system 130 includes a user profile store 305, an edge store 310, a content store 315, an advertisement store 320, a grouping module 325, an action logger 330, an action log 335, an auction module 340, a social context module 345, and a communications module 350. In other embodiments, the social networking system 130 may include additional, fewer, or different modules for various applications. Conventional components such as network interfaces, security functions, load balancers, failover servers, management and network operations consoles, and the like are not shown so as to not obscure the details of the system architecture.

User account information and other related information for users are stored as user profile objects in user profile store 305. For example, each user of the social networking system 130 has an associated user identifier that is unique to the user and is part of their user account information. The user identifier is stored in a user profile maintained by the user profile store 305. The user profile information stored in user profile store 305 also describes the users of the social networking system 130, including biographic, demographic, and other types of descriptive information, such as work experience, educational history, gender, hobbies or preferences, location, and the like. User profile information may also store other information provided by the user, for example, images or videos. In certain embodiments, images of users may be tagged with identification information of users of the social networking system 130 displayed in an image. The user profile store 305 also maintains references to the actions stored in an action log 335 and performed on objects in the content store 315. The user profile store 305 also includes data in a user profile indicating whether a user corresponding to the user profile is currently logged into social networking system 130. Additionally, a user profile may include information received from the mobile device 105 identifying content accessed or viewed by the user via the mobile device 105. This allows the user profile to include information describing content viewed by the user, which may be used to subsequently select advertisements or other content for presentation to the user. In one embodiment, the content is associated with an advertiser identifier or other information allowing an advertiser to be determined from the content.

The edge store 310 stores the information describing connections between users and other objects on the social networking system 130 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 130, such as expressing interest in a page on the social networking system 130, sharing a link with other users of the social networking system 130, and commenting on posts made by other users of the social networking system 130.

The edge store 310 also includes information about the edge, such as affinity scores for objects, interests, and other users. Affinity scores may be computed by the social networking system 130 over time to approximate a user's affinity for an object, interest, and other users in the social networking system 130 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge in the edge store 310, in one embodiment. For example, a user that plays multiple songs from Miles Davis' album, “Kind of Blue,” may have multiple edges between the user and different songs, but a single edge between the user and an object for Miles Davis.

The content store 315 stores content items associated with a user profile, such as images, videos, and audio files. Content items from the content store 315 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system, or to increase interaction with the social networking system 130 by displaying content related to users, objects, activities, or functionalities of the social networking system. Examples of social networking content items include suggested connections or suggestions to perform other actions, media provided to, or maintained by, the social networking system 130 (e.g., pictures or videos), status messages or links posted by users to the social networking system 130, events, groups, pages (e.g., representing an organization or commercial entity), and any other content provided by or accessible via the social networking system 130.

In one embodiment, advertisement objects (“ad objects”) are stored in the advertisement store 320; however, in other embodiments, ad objects may be stored in the content store 315. Ad objects may be received from one or more of advertisers 135 and the ad exchange 140. An ad object includes an advertisement and an associated bid amount and may also include targeting criteria specifying one or more characteristics of a user eligible to be presented the advertisement. The bid amount specifies an amount of compensation an advertiser 135 will provide the social networking system 130 for presenting the advertisement to a user, for receiving a user interaction with the advertisement, or based on any other suitable criteria. The bid amount may be used to determine an expected value to the social networking system 130 for presenting an advertisement to a user. For example, the bid amount specifies a monetary amount that the social networking system 130 receives from the advertiser if the advertisement is displayed and the expected value is determined by multiplying the bid amount by a probability of the advertisement being accessed.

In one embodiment, the social networking system 130 includes a grouping module 325 that retrieves targeting criteria from received ad objects. The grouping module 325 accesses information about users from the user profile store 305, the edge store 315 and/or the action log 335 to identify users satisfying one or more targeting criteria. In one embodiment, the grouping module 325 associates groups of users with targeting criteria satisfied by users in a group. A group of user profiles includes users that have some common characteristic satisfying targeting criteria associated with the group. For example, a group of users includes user identifiers associated with one or more users.

The grouping module 325 may associate one or more advertisements with a group of users to expedite selection of users satisfying targeting criteria associated with the advertisement. For example, the social networking system 130 retrieves targeting criteria from an advertiser to target one or more advertisements to users that have previously checked-in to a specified location. More generally, targeting criteria associated with advertisements may be used to identify any edge, action, characteristic or other information for identifying users to received the advertisement. From the targeting criteria and accessed information, the grouping module 325 identifies groups of users having the characteristics specified by the targeting criteria (e.g., having performed the check-in action to the specified location). User identifiers associated with users satisfying the targeting criteria are included in the group of users, which may be associated with the targeting criteria or with the advertisement. In some embodiments, targeting criteria associated with an advertisement may not necessarily include objects. For example, to advertise for a local marathon, an advertisement may include targeting criteria to identify users that have previously run a marathon.

The action logger 330 receives communications about user actions on and/or off the social networking system 130, and populates the action log 335 with information about user actions. Such actions may include, for example, adding a connection to another user, sending a message to another user, uploading an image, reading a message from another user, viewing content associated with another user, attending an event posted by another user, among others. In addition, a number of actions described in connection with other objects are directed at particular users, so these actions are associated with those users as well. These actions are stored in the action log 335.

Users may interact with various objects on the social networking system 130, including commenting on posts, sharing links, and checking-in to physical locations via mobile device 105, accessing content items in a sequence, or other interactions. Information describing these actions is stored in the action log 335. Additional examples of interactions with objects on the social networking system 130 included in the action log 335 include commenting on a photo album, enabling communications between users, becoming a fan of a musician, adding an event to a calendar, joining a group, becoming a fan of a brand page, creating an event, authorizing an application, using an application, and engaging in a transaction. Additionally, the action log 335 records a user's interactions with advertisements on the social networking system 130 as well as other applications operating on the social networking system 130.

The action log 335 may also store user actions taken on external websites. For example, an e-commerce website that primarily sells sporting equipment at bargain prices may recognize a user of a social networking system 130 through social plug-ins that enable the e-commerce website to identify the user of the social networking system 130. Because users of the social networking system 130 are uniquely identifiable, e-commerce websites, such as this sporting equipment retailer, may use the information about these users as they visit their websites. The action log 335 records data about these users, including webpage viewing histories, advertisements that were engaged, purchases made, and other patterns from shopping and buying.

The auction module 340 selects advertisements from the advertisement store 320 for presentation to a user, such as presentation via a client application 110 on the mobile device 105. In one embodiment, the auction module 340 accesses the advertisement store 320 and/or the grouping module 325 to identify candidate advertisements for presentation to a user. Alternatively, the auction module 340 receives requests for advertisements including a user identifier and identifies candidate advertisements from the advertisement store 320 associated with targeting criteria that the identified user satisfies. Based on bid prices associated with the candidate advertisements, the auction module 340 ranks the candidate advertisements and uses the ranking to select an advertisement for presentation by the mobile device 105. In various embodiments, the auction module 340 performs an internal auction, an external auction, or both, to select an advertisement to provide to the client application 110. For example, the auction module 340 determines expected values for the candidate advertisements based on their associated bid amounts and the likelihood of the identified user accessing various candidate advertisements.

In some embodiments, the auction module 340 may base its advertisement selections at least in part on other information about the user stored on the social networking system 130. For example, stored information about the user in the user profile store 305 indicates advertisers from which the user has previously viewed content. For example, a user profile identifies identifiers that a user has previously viewed, so accessing the user profile indicates content that the user has previously accessed. Additional information associated with a user by the social networking system may also be used in advertisement selection. For example, connections between the user and the advertiser may be retrieved from the edge store 310 and used as a factor in selecting advertisements. The auction module 340 may retrieve information from the action log 335, the content store 315, the advertisement store 320, some other module, or some combination thereof, to determine what content the user has previously viewed. For example, the retrieved information may indicate that the user had recently viewed content from Jack's Bow Hunting Supply. The auction module 340 would then weight any candidate advertisement from Jack's Bow Hunting Supply such that it has an increased probability of being selected (e.g., increases the expected value of the advertisement). Associating content that a user has accessed with the user's user profile allows a record of the content accessed by a user to be maintained, even when the content is accessed from sources that do not support cookies or other conventional tracking, such as applications on mobile devices 105. Similarly, if the user was associated with Jack's Bow Hunting Supply, candidate advertisements from Jack's Bow Hunting Supply would also have an increased weight.

In some cases, the user ID information 125 in a request for an advertisement is associated with multiple users. The auction module 340 may identify a subset of the users identified by the user ID information 125. In one embodiment, the auction module 340 selects the user identifiers from the request for an advertisement that are associated with a user currently logged into the social networking system 130 via the social networking application 120. For example, user profiles may be selected based on most recent logging into the social networking system 130, most frequently logging into the social networking system 130 or based on any other suitable criteria. Or, the auction module 340 may select user profiles from the received user ID information 125 based on connections between users in the received user ID information 125. For example, the auction module 340 selects users identified by the received user ID information 125 that are connected to a common object or that are included in the same group by the grouping module 325. For example, user ID information 125 specifies user A and user B, where user A is included in a group associated with targeting criteria X and Y, and user B is included in a group associated with targeting criteria Y and Z. In this example, the auction module 340 associates a group including targeting criteria Z with the user ID information 125. In other embodiments, the auction module 340 identifies user profiles associated with each user identifier included in the user ID information 125.

If a request for an advertisement includes one or more request parameters, the auction module 340 applies the request parameters to filter the candidate advertisements before ranking the candidate advertisements. A request parameter may specify, for example, a parameter that a candidate advertisement has not been previously provided to the client application 110, a specified size of the candidate advertisement, a threshold number of times the candidate advertisement has been provided to the client application 110, a threshold expected value associated with the candidate advertisement, content of the candidate advertisement, or some combination thereof.

If the user identified by the user ID information 215 satisfies targeting criteria for multiple advertisements, auction module 130 may select specific targeting criteria and rank the advertisements associated with the selected targeting criteria. Auction module 130 may select which targeting criteria to select based on characteristics of the advertisements associated with the targeting criteria. For example, targeting criteria associated with advertisements having the highest average expected value, having the highest or lowest frequency of display or any other applicable characteristics may be selected. In other embodiments, auction module 130 may conduct auctions including ads without limiting the advertisements included in the auction.

Social context module 345 identifies social context information associated with a user identified by the user ID information 125 for inclusion in a selected advertisement. For example, social context module 345 retrieves data from the user profile store 305 to determine if a user associated with the user ID information 125 is currently logged into the social networking system 130. If the user is logged in, the social context module 345 identifies users connected to the user from the user profile store 305 and/or the edge store 310 and identifies actions or characteristics of the users connected to the user from the user profile store 305 or from the action log 335. FIG. 1B includes an example of embedded social context information, specifically, “Brian and Dave like Robin's Archery Supply” embedded in the targeted advertisement 150.

Communications module 350 is configured to transmit and receive data, via network 220, from social networking system 130 to a mobile device 105 and/or to another component. The communications module 350 receives requests for advertisements from one or more requesting mobile devices 105 and communicates information from the requests for advertisements to components of the social networking system 130. Additionally, communications module 350 sends an advertisement selected by the social networking system 130, as well as embedded social context information, to the requesting mobile device 105 via the network 220.

### Selection of Advertisements for Mobile Device Users

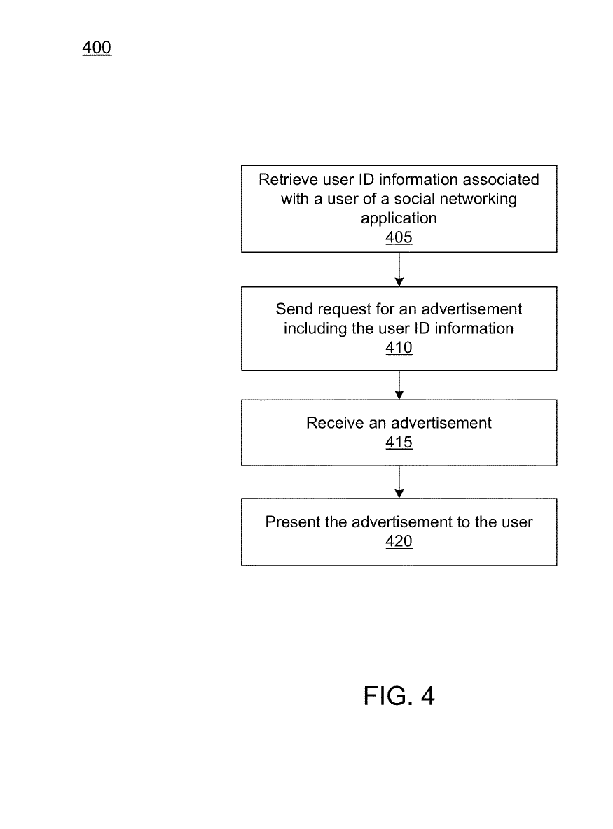

FIG. 4 is a flow chart of one embodiment of a process 400 for retrieving a targeted advertisement from a social networking system 130 using a mobile device 105. A client application 110 operating on the mobile device retrieves 405 user ID information 125 associated with a user of the social networking application 120 operating on the mobile device 105 from a shared memory location in the mobile device 105. Hence, the social networking application 120 stores the user ID information 125 in the shared memory location of the mobile device 105, so that other applications, such as the client application 110, may retrieve the user ID information 125. In some embodiments, the client application 110 includes the advertising application 115 that retrieves 405 the user ID information 125 from the shared memory location.

Based on the retrieved user ID information 125, the client application 110 sends 410 a request for an advertisement including the retrieved user ID information 125 to the social networking system 130.

The social networking system 130 processes the request for an advertisement and selects an advertisement for presentation via the client application 110. For example, the social networking system 130 may base the selection on targeting criteria associated with advertisements stored by the social networking system, and/or information about the user stored by the social networking system 130. In some embodiments, the stored information about the user indicates that the user has previously viewed content from, or is associated with, the candidate target advertisements' advertisers.

The selected advertisement is received 415 by the client application 110, or by the advertising application 115 and is presented 420 to the user via the client application 110. For example, the client application 110 displays the targeted advertisement to the user, plays audio associated with the selected targeted advertisement, etc.

### Selection of Advertisements for Online System Users

As users may interact with the online system using various types of devices, such as mobile devices 105 and 107, users may interact with content, such as advertisements, from the online system from various devices. Conventional techniques for advertisement selection are limited to identifying interactions between a user and an advertisement from a particular type of device. Hence, when selecting advertisements for a computing device 107, a conventional online system may account for prior interactions with advertisements from computing devices 107, but is unable to account for interactions with advertisements via mobile devices 105. This may result in similar advertisements being presented to the same user via different types of devices, reducing the likelihood of user interaction with advertisements as they become repetitive across different types of devices.

Communicating a description of a user's interaction with an advertisement presented by a mobile device 105 that includes user ID information retrieved from a shared memory location of the mobile device 105 allows the online system to identify the advertisement with which the user interacted via the mobile device 105. For example, the user ID information is retrieved from a shared memory location of the mobile device 105 used by an application associated with the online system and an application presenting advertisements via the mobile device 105. In one embodiment, the social networking application 120 stores user ID information in the shared memory location and the advertisement application 115 retrieves the user ID information from the shared memory location and communicates a description of an interaction with an advertisement to the social networking system 130 including the user ID information. The online system stores a description of the advertisement and the interaction with the advertisement in a user profile identified from the user ID information.

Additionally, the online system may retrieve information from cookies stored on computing devices 107 describing interactions with advertisements presented via a computing device 107. The cookie may include user ID information for identifying a user of the online system interacting with the advertisement using the computing device 107 as well as the advertisement and type of interaction with the advertisement. Information from the cookie describing an advertisement and an interaction with the advertisement are stored in the user profile associated with the user ID information by the online system.

Hence, a user profile maintained by the online system includes information describing advertisements with which a user corresponding to the user profile interacted. Additional information about the interactions may also be included in the user profile. For example, a type of interaction may be stored and associated with a description of an advertisement. Additionally, a device type may be identified, allowing the online system to determine whether the interaction was performed using a mobile device 105 or using a computing device 107. Further information, such as an application identifier or type of application may also be stored in the user profile.

When the online system receives a request to present an advertisement, the online system retrieves user ID information from the request and identifies a user profile associated with the user ID information. From the user profile, the online system identifies advertisements with which a user corresponding to the user profile previously interacted and selects an advertisement for presentation to the user based on the advertisements with which the user previously interacted. For example, the online system excludes advertisements with which the user previously interacted from selection to present a wider range of advertisements to the user. Because the user profile identifies advertisements with which the user interacted using various types of devices, such as mobile devices 105 as well as computing devices 107, the likelihood that a user is presented with a duplicate advertisement is reduced. For example, if a user interacts with an advertisement via a mobile device 105, retrieving the user ID from the shared memory of the mobile device 105 allows the user profile to reflect the user's interaction with the advertisement; subsequently, if a request to present an advertisement to the user is received form a computing device 107, based on the user profile, the online system accounts for the prior interaction with the advertisement via the mobile device 105 to prevent selecting the advertisement, or an advertisement with similar characteristics, via the computing device 107.

In one embodiment, the request to present an advertisement to a user may also identify a type of device on which the advertisement is to be presented. For example, the request indicates whether a mobile device 105 or a computing device 107 is presenting the requested advertisement. The online system may use the identified type of device to select an advertisement. For example, the online system may select an advertisement presented to the user more than a threshold amount of time from the current time using a type of device differing from the type of device included in the request. Additionally, the information in the user profile describing interactions with advertisements by a user may identify a type of application used to interact with an advertisement. The request to present an advertisement may specify a type of application to present the advertisement, allowing the online system to account for the types of applications previously used to interact with advertisements and used to present the advertisement when selected an advertisement.

### SUMMARY

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A method comprising:
receiving a description of an interaction with an advertisement presented to a user of an online system via a computing device from a cookie stored on the computing system, the cookie including user identifying information associated with the user of the online system;
identifying a user profile of the user maintained by the online system from the user identifying information included in the cookie;
storing the description of the interaction with the advertisement presented to a user of the online system via the computing device in the user profile;
receiving an interaction with an advertisement presented to the user of the online system via a mobile device, the interaction including user identification information associated with a user of a social networking system and provided by an application operating on the mobile device associated with the online system;
identifying the user profile of the user maintained by the online system from the user identifying provided by the application;
storing the description of the interaction with the advertisement presented to a user of the online system via the mobile device in the user profile;
receiving a request for an additional advertisement for the user from a requesting device, the request including the user identifying information;
identifying advertisements with which the user interacted from the descriptions of interactions stored in the user profile;
selecting the additional advertisement based at least in part on the identified advertisements with when the user interacted; and
providing the selected advertisement to the requesting device for presentation to the user.

2. The method of claim 1, wherein selecting the additional advertisement based at least in part on the identified advertisements with when the user interacted comprises:
selecting an advertisement with which the user has not previously interacted.

3. The method of claim 1 wherein description of the interaction with the advertisement presented to the user of the online system via the computing device identifies the advertisement presented to the user of the online system via the computing device, an indication the computing device was used for the interaction with the advertisement presented to the user of the online system via the computing device, and a time of the interaction with the advertisement presented to the user of the online system via the computing device.

4. The method of claim 1, wherein the request for the additional advertisement includes a type of device presenting the additional advertisement.

5. The method of claim 4, wherein the type of device is a mobile device or a computing device.

6. The method of claim 5, wherein selecting the additional advertisement based at least in part on the identified advertisements with when the user interacted comprises:
selecting an advertisement presented to the user more than a threshold amount of time from a current time using a type of device different than type of device presenting the additional advertisement.

7. A method comprising:
receiving interactions with advertisements presented to a user from an online system from a plurality of types of computing devices, each interaction with an advertisement including user identifying information associated with the user and a type associated with a computing device from which the interaction was performed;
retrieving a user profile associated with the user by the online system;
storing descriptions identifying advertisements with which the user interacted in the user profile;
receiving a request for an additional advertisement for the user from a requesting device, the request including the user identifying information;
identifying advertisements with which the user interacted from the user profile;
selecting the additional advertisement based at least in part on the identified advertisement with when the user interacted; and
providing the selected advertisement to the requesting device for presentation to the user.

8. The method of claim 7, wherein a description further identifies a type associated with a computing device from which the user interacted with an advertisement identified by the description.

9. The method of claim 8, wherein the type specifies whether the user interacted with the advertisement identified by the description using a mobile device.

10. The method of claim 7, wherein selecting the additional advertisement based at least in part on the identified advertisements with when the user interacted comprises:
selecting an advertisement with which the user has not previously interacted.

11. The method of claim 7 wherein a description identifies an advertisement, a type of device used to interact with the advertisement, and a time when the user interacted with the advertisement.

12. The method of claim 11, wherein the request for the additional advertisement includes a type of device presenting the additional advertisement.

13. The method of claim 12, wherein selecting the additional advertisement based at least in part on the identified advertisements with when the user interacted comprises:
selecting an advertisement presented to the user more than a threshold amount of time from a current time using a type of device different than type of device presenting the additional advertisement.

14. The method of claim 1, wherein a description further identifies a type of application from which the user interacted with an advertisement identified by the description.

15. The method of claim 14, wherein the request for the additional advertisement includes a type of application presenting the additional advertisement.

16. The method of claim 15, wherein selecting the additional advertisement based at least in part on the identified advertisements with when the user interacted comprises:
selecting an advertisement with which a user has not previously interacted using the type of application included in the request.

17. A method comprising:
receiving interactions with advertisements presented to a user of a social networking system, the interactions received from a plurality of types of computing devices, each interaction with an advertisement including user identifying information associated with the user and a type associated with a computing device from which the interaction was performed;
retrieving a user profile associated with the user by the social networking system;
storing descriptions identifying advertisements with which the user interacted in the user profile, a description identifying an advertisement and a type associated a computing device used to interact with the advertisement;
receiving a request for an additional advertisement for the user from a requesting device, the request including the user identifying information;
identifying advertisements with which the user interacted from the user profile;
selecting the an advertisement not identified by the user profile as the; and
providing the selected advertisement to the requesting device for presentation to the user.
